(19) United States
(12) Patent Application Publication
(10) Pub. No.: US 2013/0331090 A1
(43) Pub. Date: Dec. 12, 2013

(54) APPARATUS FOR PERFORMING UE-TO-UE COOPERATIVE COMMUNICATION IN A WIRELESS COMMUNICATION SYSTEM AND METHOD THEREOF

(71) Applicant: LG Electronics Inc., Seoul (KR)

(72) Inventors: Dongcheol KIM, Anyang-si (KR); Jiwoong JANG, Anyang-si (KR); Hangyu CHO, Anyang-si (KR); Jiwon KANG, Anyang-si (KR); Sungho PARK, Anyang-si (KR); Dongguk LIM, Anyang-si (KR)

(21) Appl. No.: 13/911,931

(22) Filed: Jun. 6, 2013

Related U.S. Application Data
(60) Provisional application No. 61/656,532, filed on Jun. 7, 2012.

(51) Int. Cl. H04W 76/02

(52) U.S. Cl. CPC H04W 76/023
USPC 455/422.1

(57) ABSTRACT

An apparatus and method for performing UE-to-UE cooperative communication in a wireless communication system are disclosed, by which implementation of a UE cooperative communication using a cellular network is facilitated. The present invention includes activating an application to perform the UE-to-UE cooperative communication, receiving first data via a first network from a base station recognizing that the application has been activated, receiving second data via a second network from a cooperative user equipment linked for the UE-to-UE cooperative communication, and performing a service by adding the first data and the second data together through the application, wherein the first network and the second network correspond to heterogeneous networks, respectively.

Pursuant to 35 U.S.C. §119(e), this application claims the benefit of priority to Provisional Application No. 61/656,532, filed on Jun. 7, 2012, the contents of which are all hereby incorporated by reference herein in their entirety.

### BACKGROUND OF THE INVENTION

1. Field of the Invention

The present invention relates to a wireless communication system, and more particularly, to an apparatus for performing UE-to-UE cooperative communication in a wireless communication system and method thereof.

2. Discussion of the Related Art

In short range communication, a communication between user equipments (hereinafter named UE-to-UE communication) is generally defined as a peer-to-peer communication. Entities of this communication mutually perform communications in accordance with a mutually defined and agreed random access scheme. And, it is not necessary to consider whether one of the entities is actually connected to a public internet network. On the other hand, a cellular network communication should be defined as a communication between a base station and a user equipment or a communication between an entity equivalent to a base station and a user equipment and all communication behaviors are controlled by a base station or an entity equivalent to the base station. In this protocol, a cellular network restricts operations of all user equipments by a predetermined rule, thereby having a structure for obtaining maximum throughput.

On the other hand, this rule has an over-ruled aspect depending on a channel environment of a user equipment or the like. For instance, a base station makes a decision of a power consumed for a user equipment to transmit the same data traffic. As all behaviors of the user equipment in transmitting the same data traffic are controlled or regulated by a base station, a short range communication should operate in a manner that the base station exists in between.

However, any efforts have not been made to research and develop a method of enabling a cooperative communication in a cellular network based communication system for enabling a short range communication with low power consumption. Therefore, the present invention proposes such a method.

### SUMMARY OF THE INVENTION

Accordingly, embodiments of the present invention are directed to an apparatus for performing UE-to-UE cooperative communication in a wireless communication system and method thereof that substantially obviate one or more problems due to limitations and disadvantages of the related art.

One object of the present invention is to provide a method for a user equipment to perform UE-to-UE cooperative communication in a wireless communication system according to one embodiment of the present invention.

Another object of the present invention is to provide a method for a user equipment to perform UE-to-UE cooperative communication in a wireless communication system according to another embodiment of the present invention.

A further object of the present invention is to provide a user equipment for performing a method of performing UE-to-UE cooperative communication in a wireless communication system according to one embodiment of the present invention.

Another further object of the present invention is to provide a user equipment for performing a method of performing UE-to-UE cooperative communication in a wireless communication system according to another embodiment of the present invention.

Technical tasks obtainable from the present invention are non-limited by the above-mentioned technical tasks. And, other unmentioned technical tasks can be clearly understood from the following description by those having ordinary skill in the technical field to which the present invention pertains.

Additional advantages, objects, and features of the invention will be set forth in the disclosure herein as well as the accompanying drawings. Such aspects may also be appreciated by those skilled in the art based on the disclosure herein.

To achieve these objects and other advantages and in accordance with the purpose of the invention, as embodied and broadly described herein, a method of performing a UE-to-UE cooperative communication by a user equipment (UE) in a wireless communication system, according to one embodiment of the present invention includes the steps of activating an application to perform the UE-to-UE cooperative communication, receiving first data via a first network from a base station recognizing that the application has been activated, receiving second data via a second network from a cooperative user equipment linked for the UE-to-UE cooperative communication, and performing a service by adding the first data and the second data together through the application, wherein the first network and the second network correspond to heterogeneous networks, respectively. Preferably, the method may further include transmitting related information for the UE-to-UE cooperative communication to the base station in accordance with the application activation. More preferably, the related information for the UE-to-UE cooperative communication may include information indicating that the user equipment includes a final user equipment receiving the first data and the second data and that the cooperative user equipment includes a user equipment forwarding the second data received from the base station to the user equipment and a cooperative communication group identifier information for identifying user equipments by cooperative communication groups. More preferably, the related information for the UE-to-UE cooperative communication may further include information on a service requested to the base station by the user equipment. Preferably, the first network may include a cellular network and the second network may include a WiFi network. Preferably, the method may further include the step of forming a link for the cooperative communication with the cooperative user equipment in a manner of discovering neighbor user equipments for the UE-to-UE cooperative communication and setting a prescribed one of the discovered user equipments as the cooperative user equipment.

In another aspect of the present invention, a method of performing a UE-to-UE cooperative communication, which is performed by a user equipment (UE) in a wireless communication system, according to another embodiment of the present invention includes the steps of activating an application to perform the UE-to-UE cooperative communication, receiving first data via a first network from a base station recognizing that the application has been activated, and transmitting the received first data to a user equipment linked to the user equipment for the UE-to-UE cooperative communication via a second network using the application, wherein the first network and the second network correspond to heterogeneous networks, respectively. Preferably, the method may further include transmitting related information for the UE-to-UE cooperative communication to the base station in accordance with the application activation. More preferably, the related information for the UE-to-UE cooperative communication may include information indicating that the user equipment includes a final user equipment receiving the first data and the second data and that the cooperative user equipment includes a user equipment forwarding the second data received from the base station to the user equipment and a cooperative communication group identifier information for identifying user equipments by cooperative communication groups. Preferably, the first network may include a cellular network and wherein the second network comprises a WiFi network.

In a further aspect of the present invention, a user equipment for performing a UE-to-UE cooperative communication in a wireless communication system, the user equipment according to a further embodiment of the present invention includes a receiver and a processor configured to activate an application to perform the UE-to-UE cooperative communication, the processor controlling the receiver to receive first data via a first network from a base station recognizing that the application has been activated, the processor controlling the receiver to receive second data via a second network from a cooperative user equipment linked for the UE-to-UE cooperative communication, the processor controlling a service to be performed by adding the first data and the second data together through the application, wherein the first network and the second network correspond to heterogeneous networks, respectively. Preferably, the user equipment may further include a transmitter, the processor controlling the transmitter to transmit related information for the UE-to-UE cooperative communication to the base station in accordance with the application activation. More preferably, the related information for the UE-to-UE cooperative communication may include an information indicating that the user equipment includes a final user equipment receiving the first data and the second data and that the cooperative user equipment includes a user equipment forwarding the second data received from the base station to the user equipment and cooperative communication group identifier information for identifying user equipments by cooperative communication groups.

In another further aspect of the present invention, a user equipment for performing a UE-to-UE cooperative communication in a wireless communication system, the user equipment according to another further embodiment of the present invention includes a receiver, a transmitter, and a processor configured to activate an application to perform the UE-to-UE cooperative communication, the processor controlling the receiver to receive first data via a first network from a base station recognizing that the application has been activated, the processor controlling the transmitter to transmit the received first data to a user equipment linked to the user equipment for the UE-to-UE cooperative communication via a second network using the application, wherein the first network and the second network correspond to heterogeneous networks, respectively. Preferably, the processor may control the transmitter to further transmit related information for the UE-to-UE cooperative communication to the base station in accordance with the application activation.

Accordingly, the present invention provides the following effects and/or advantages.

First of all, according to various embodiments of the present invention, implementation of a UE cooperative communication using a cellular network is facilitated. Such a UE cooperative communication method using a cellular network may be effective in case that a final UE and a cooperative UE differs from each other in communication environment or that a power owned by the final UE is low. The present invention enables a cooperative communication for enhancing communication performance in a manner as follows. First of all, a cooperative UE in a good communication environment forwards a partial data from a base station to a final UE in a poor communication environment. Secondly, a final UE receives data of a base station from a cooperative UE if the final UE needs to receive data at a low power level due to a weak power currently owned by the final UE.

Effects obtainable from the present invention may be non-limited by the above mentioned effect. And, other unmentioned effects can be clearly understood from the following description by those having ordinary skill in the technical field to which the present invention pertains.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. The above and other aspects, features, and advantages of the present invention will become more apparent upon consideration of the following description of preferred embodiments, taken in conjunction with the accompanying drawing figures. In the drawings:

FIG. 1 is a schematic block diagram for device configurations of a user equipment and a network node according to an embodiment of the present invention;

FIG. 2 is a diagram for one example to describe a UE cooperative communication architecture according to the present invention;

FIG. 3 is a diagram to describe a 3GPP cellular network architecture and a cooperative communication method according to one embodiment of the present invention;

FIG. 4 is a diagram for one example to describe a UE cooperative communication method according to a 1^{st} embodiment of the present invention;

FIG. 5 is a diagram for one example to describe a UE cooperative communication method according to a 2^{nd} embodiment of the present invention;

FIG. 6 is a diagram for one example of simplifying the procedure according to the 1^{st} embodiment of the present invention;

FIG. 7 is a diagram for one example of simplifying the procedure according to the 2^{nd} embodiment of the present invention; and

FIG. 8 is a diagram for a UE cooperative communication and handover according to an embodiment of the present invention.

### DETAILED DESCRIPTION OF THE INVENTION

Reference will now be made in detail to the preferred embodiments of the present invention, examples of which are illustrated in the accompanying drawings. In the following detailed description of the invention includes details to help the full understanding of the present invention. Yet, it is apparent to those skilled in the art that the present invention can be implemented without these details.

Occasionally, to prevent the present invention from getting vaguer, structures and/or devices known to the public are skipped or can be represented as block diagrams centering on the core functions of the structures and/or devices. Wherever possible, the same reference numbers will be used throughout the drawings to refer to the same or like parts.

Besides, in the following description, assume that a terminal or device is a common name of such a mobile or fixed user stage device as a user equipment (UE), a mobile station (MS), an advanced mobile station (AMS), and the like. And, assume that a base station is a common name of such a random node of a network stage communicating with a terminal as a Node B, an eNode B, a base station (BS), an access point (AP) and the like.

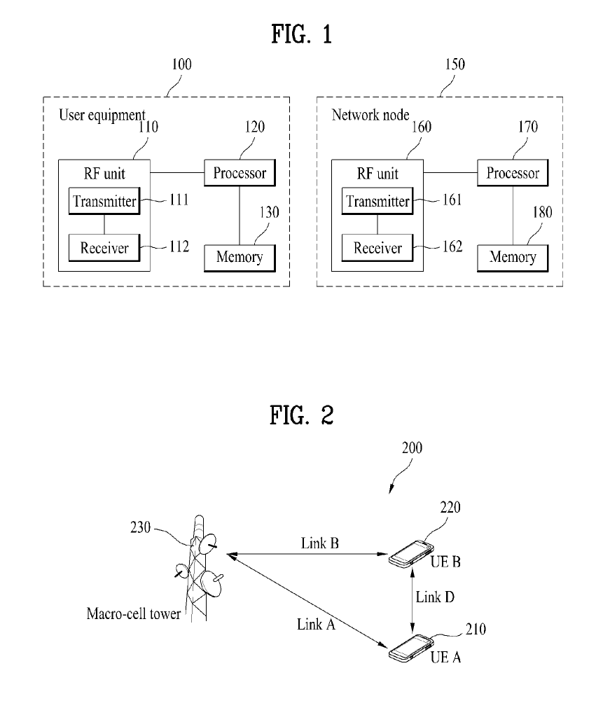

FIG. 1 is a schematic block diagram for device configurations of a user equipment and a network node according to an embodiment of the present invention.

Referring to FIG. 1, a user equipment may include an RF unit 110, a processor 120 and a memory 130 that is optional. And, a network node (e.g., a base station) 150 may include an RF unit 160, a processor 170 and a memory 180 that is optional. The RF unit 110/160 may include a transmitter 111/161 and a receiver 112/162. For example of the user equipment 100, the transmitter 111 and the receiver 112 are configured to transceive signals with the network node 150 and other user equipments. The processor 120 may be configured to control a process for the transmitter 111 and the receiver 112 to transceive signals with other devices in a manner of being functionally connected to the transmitter 111 and the receiver 112. The processor 120 performs various kinds of processings on a signal to transmit and then transmits the processed signal to the transmitter 111. And, the processor 120 is able to perform a processing on a signal received by the receiver 112. If necessary, the processor 120 may control information contained in an exchanged message to be saved in the memory 130. The above-configured user equipment 100 can implement methods according to various embodiments explained in the following description.

The user equipment 100 may further include various kinds of additional configurations (not shown in the drawing) in accordance with its device type. For instance, in case that the corresponding user equipment 100 is provided for the intelligent metering, it may include an additional configuration for power measurement and the like. This power measuring operation may be performed under the control of the processor 120 shown in FIG. 1 or a separately configured processor (not shown in the drawing). Although FIG. 1 shows one example of a case that a communication is performed between the user equipment 100 and the network node 150, each network node may have the same configuration of the device shown in FIG. 1, thereby implementing the various embodiments of the method mentioned in the following description.

On the other hand, the transmitter 161 and the receiver 162 of the network node 150 are configured to transceive signals with other network nodes. The processor 170 may be configured to control a process for the transmitter 161 and the receiver 162 to transceive signals with other devices in a manner of being functionally connected to the transmitter 161 and the receiver 162. The processor 170 performs various kinds of processings on a signal to transmit and then transmits the processed signal to the transmitter 161. And, the processor 170 is able to perform a processing on a signal received by the receiver 162. If necessary, the processor 170 may control information contained in an exchanged message to be saved in the memory 180. The above-configured network node 150 may be able to implement various embodiments of a method mentioned in the following description.

The processor 120/170 of the user equipment/network node 110/150 directs (e.g., control, coordinate, manage, etc.) an operation of the user equipment/network node 110/150. The processor 120/170 may be connected to the memory 130/180 configured to store program codes and data. The memory 130/180 is connected to the processor 120/170 to store operating systems, applications and general files.

The processor 120/170 may be called one of a controller, a microcontroller, a microprocessor, a microcomputer and the like. And, the processor 120/170 may be implemented using hardware, firmware, software and/or any combinations thereof. In case of implementing the embodiments of the present invention using hardware, the processor 120/170 may be provided with such a device configured to implement the present invention as ASICs (application specific integrated circuits), DSPs (digital signal processors), DSPDs (digital signal processing devices), PLDs (programmable logic devices), FPGAs (field programmable gate arrays), and the like.

Meanwhile, in case of implementing the embodiments of the present invention using firmware or software, the firmware or software may be configured to include modules, procedures, and/or functions for performing the above-explained functions or operations of the present invention. And, the firmware or software configured to implement the present invention is loaded on the processor 120/170 or saved in the memory 130/180 to be driven by the processor 120/170.

In the present specification, assume that other functions are processed by the processor 120/170 except a function for the user equipment/network node 100/150 to transceive signals with other nodes and a saving function.

As mentioned in the foregoing description, in order to enable a short range communication with low power consumption, a user equipment should have a structure of utilizing another radio access technology (RAT) or may accept the inconvenience of a cellular network as it is.

In case that a cellular network is used only, when a network is accessed due to a poor channel environment of a user equipment, some restriction is put on using an optimal communication path by finding a new access path. Hence the user equipment can utilize another radio access technology (RAT). In particular, in case that a user equipment has a good channel established with another neighbor user equipment despite being included in a shadow area, it is able to utilize another RAT. In this case, the user equipment communicates with a neighbor user equipment using another RAT (e.g., WiFi) and a user equipment having a corresponding channel in good condition communicates with a base station via a cellular network, thereby enhancing power efficiency and throughput of a user equipment (i.e., a final UE) that becomes a source of data traffic.

For another example, if a user equipment intends to communicate with a neighbor user equipment by utilizing RAT of a cellular network only instead of using another RAT with the cellular network, transceiving the corresponding data is under the control of a base station. Yet, even if user equipments are physically located so close to each other, the corresponding data should be retransmitted to a destined user equipment in a manner of being necessarily forwarded to a base station, which is accompanied by an unreasonable communication architecture. In case that M2M (machine to machine) devices exist and are managed, such an application may consider a model configured in a manner that a specific device plays a role as an aggregator when an M2M server accesses each of the M2M devices via a base station. According to another application, an owner, who manages M2M devices, manages the corresponding devices by neighboring to the corresponding devices, data is preferably delivered to a management device of the corresponding owner in direct rather than delivered to a base station. In doing so, if this case is compared to a case of using another RAT (e.g., WiFi, Bluetooth, Zigbee, etc.), a user equipment can configure an inexpensive eco-system because the user equipment does not need to include a modem for multiple RATs. Moreover, since the multiple RAT is not used, it is not necessary to implement a processing configuration for an unnecessary application layer.

Moreover, by implementing an integrative design of an air-interface for a UE-to-UE communication and a UE-to-BS communication based on a single RAT, it is able to overcome inefficiency that may happen in independently implementing a multi-RAT based design. In particular, if a short range communication and a cellular network access are allowed by utilizing a single RAT, it is able to configure a very efficient eco-system of M2M devices. This feature may apply to a human device in the same manner. In doing so, both of a short range communication and a long range communication can be performed via a low complexity device with small power and an active QoS management is enabled to make an efficient power consumption level or throughput management.

In the following description, as a method of supporting a UE-to-UE cooperative communication for supporting multi-network communications, a method of performing a UE-to-UE cooperative communication using a cellular communication based short-range network (e.g., WiFi, Bluetooth, Zigbee, etc.) is explained. As a method of enabling a cooperative communication in a cellular network based communication system, the present invention is described in a manner suitable for a case of supporting a heterogeneous network (e.g., the same communication method, a different communication method).

FIG. 2 is a diagram for one example to describe a UE cooperative communication architecture according to the present invention.

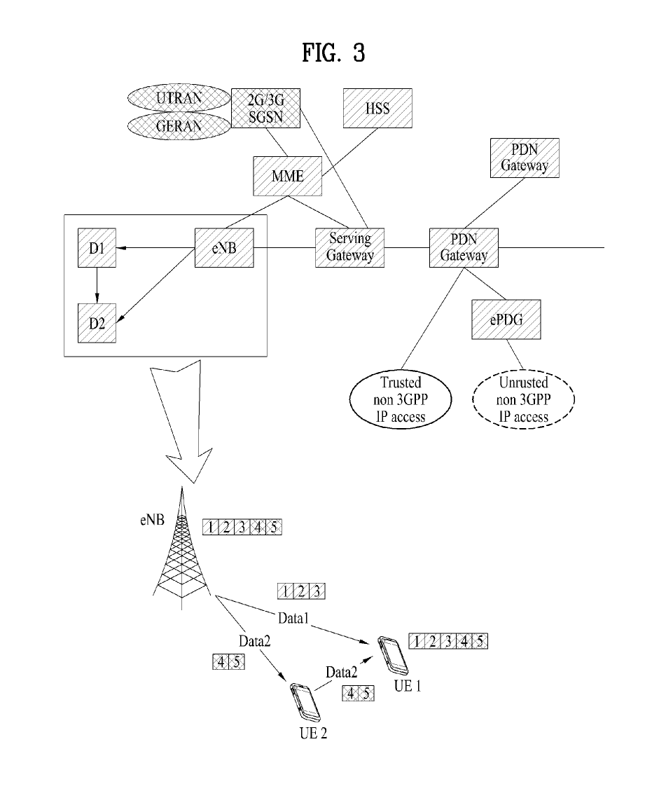

Referring to FIG. 2, in case that a signal from a base station is transmitted to a UE B (user equipment B) 220 with the help of a UE A (user equipment A) 210, the UE A 210 shall be named a cooperative UE and the UE B 200 shall be named a final UE. Since the present invention can include both a UE-to-UE direct communication and a UE-to-UE cooperative communication, the UE B is named the final UE. The present invention shall be described using the cooperative communication architecture shown in FIG. 2 as a basic concept. The cooperative communication architecture 200 may include a control tower 230 configured to control and manage a macro cell, a cooperative UE A 210 and a final UE B 220. Using this basic architecture, a process of a UE cooperative communication method performed between the UE A 210 and the UE B 220 is described with reference to FIG. 3 as follows.

FIG. 3 is a diagram to describe a 3GPP cellular network architecture and a cooperative communication method according to one embodiment of the present invention.

Referring to FIG. 3, a cellular network 300 includes an eNB (evolved Node B), an MME, an HSS (Home Subscriber Server), a Serving GW (Serving Gateway), a PDN GW (Packet Data Network Gateway), a PCRF (Policy and Charging Rules Function), a UE 1 and a UE 2. Functions of nodes included in the cellular network 300 can be described as follows.

MME: Key control and signaling element, Gateway selection, Idle state terminal location management, Bearer control

HSS (Home Subscriber Server): User subscription data

PCRF (Policy and Charging Rules Function): Gating and QoS policy control, Flow-based charging control

eNB (Evolved Node B): Radio Resource Management, User plane IP header compression and encryption

Serving GW (Serving Gateway): Bearer plane element interfacing E-UTRAN, Mobility anchor for inter-eNB and inter-3GPP access mobility

PDN GW (Packet Data Network Gateway): Bearer plane element interfacing PDNs, Terminal IP address allocation, Policy enforcement, Packet filtering, Charging

Meanwhile, the UE 1 is a final UE of the UE cooperative communication and the UE 2 is a cooperative UE of the UE cooperative communication.

The UE cooperative communication can be mainly categorized into two kinds of methods. A method for a cooperative communication varies depending on whether the final UE is performing a service (e.g., www, e-mail, P2P, FTP, streaming services, etc.).

### 1^{st} Embodiment

### UE Cooperative Communication Method while Final UE is not Performing a Service Via Base Station

First of all, UE 1 and UE 2 support a short range communication (e.g., WiFi, Bluetooth, Zigbee, NFC (near field communication), etc.) as a sub-network. The sub-network may include a UE-to-UE direct communication using a cellular communication system. And, the sub-network is used to establish a link between the UE 1 and the UE 2. The sub-network may be identical or different. According to the present invention, assume that both of the UEs (i.e., UE 1 and UE 2) support WiFi for example.

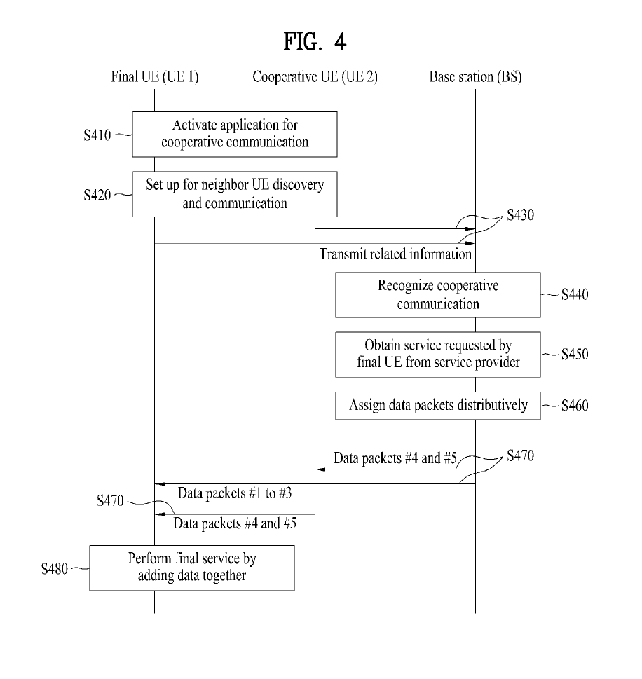

FIG. 4 is a diagram for one example to describe a UE cooperative communication method according to a 1^{st} embodiment of the present invention.

Referring to FIG. 4, a UE activates an application to enable a UE-to-UE cooperative communication [S410]. In particular, an application enabling a cooperative communication, e.g., an application in a cooperative UE may control data received from a base station to be forwarded to a final UE. On the other hand, an application in a final UE adds a data received from a base station by the final UE to a data received from a cooperative UE based on partial or whole service data to be received from the base station. The application compares the sum of the addition to information of data to be received from the base station. If the result of the comparison is normal, the application can control a corresponding service to be completed.

In FIG. 3, in order for a final UE (i.e., UE 2) to perform a reception of data perfectly, the base station, which transmits the data, and the cooperative UE (i.e., UE 1) send information on data, which is to be sent by a transmitting side, to a receiving side UE (i.e., UE 2). If there is a loss on the basis of the sent information, the receiving side UE (i.e., UE 2) gives a feedback to a transmitting side UE (i.e., UE 1), thereby receiving a retransmission of a lost packet.

Two kinds of communication modes are available between the UE 1 and the UE 2. The corresponding UE can select one of a cooperative communication mode and a simultaneous sharing mode. In the following description, one example of supporting the cooperative communication mode is explained. In the cooperative communication mode, the cooperative UE (i.e., UE 1) other than the final UE (i.e., UE 2) receives data on behalf and plays a role in helping a final UE to receive data. In the simultaneous sharing mode, all user equipments participating in the cooperative communication can share the same service of the final UE. This can be implemented in a manner that such an operating scheme as a cooperative communication mode is simultaneously or sequentially performed between user equipments that perform the cooperative communication. In particular, a single user equipment may become a cooperative UE at a predetermined timing point but may turn into a final UE to change its role.

Having activated the application, the UEs perform and complete a neighbor UE discovery process and a setup process for communication [S420]. Through these processes, a connection or link for the final UE (UE 1) and the cooperative UE (UE 2) to perform the cooperative communication.

The UE having activated the application transmits related information to the base station [S430]. The related information may include information (e.g., a cooperative communication group ID) for sorting UEs by cooperative communication groups in the application, information on each of the UEs performing the cooperative communication, and the like. The related information may be transmitted to the base station by each of the UEs. In particular, the UE 1 may transmit information indicating that it is the final UE and a cooperative communication group ID to the base station, while the UE 2 may transmit an information indicating that it is the cooperative UE and a cooperative communication group ID to the base station. Moreover, the related information may include information on a service requested to the base station by the UE 1.

On the other hand, it may consider a method for a single UE to inform a base station of information on a UE performing a cooperative communication. For instance, when a final UE informs a base station of information on a cooperative UE, the information may include such information predetermined between a base station and a UE as ID/MAC address/IP address of the cooperative UE and the like. Alternatively, UE 1 belonging to a cooperative communication group can transmit information on a cooperative communication performing UE to the base station on behalf of the final UE.

The base station can recognize that two UEs perform the cooperative communication through the application activation [S440]. The base station recognizes a cooperative UE and a final UE per UE. The base station can obtain a service (e.g., WWW, email, P2P, FTP, streaming service, etc.) requested by the final UE from such a service provider as an internet and the like [S450]. The base station can obtain whole data or predetermined unit data of the service requested by the final UE via the internet or service provider.

Subsequently, the base station can distributively assign data packets in consideration of a communication environment of UE [S460]. In particular, the base station performs distribute scheduling by predetermined rules to enable the two UEs to distribute data packets to prevent data from overlapping with each other. In FIG. 3, regarding data packets to be transmitted, data packets #1 to #3 are directly sent to the final UE. If data packets #4 and #5 are sent to the cooperative UE, the cooperative UE forwards the received data packets #4 and #5 to the final UE through application activation. The base station divides data packets into a group of data packets #1 to #3 and a group of data packets #4 and #5. The base station may transmit the grouped data packets to the two UEs simultaneously in time domain or transmit the grouped data to each of the UEs in order of time.

Thus, it is necessary to support the function of distributing a packet assigned for a final UE and a packet assigned for a cooperative UE in a manner suitable for a communication environment.

The final UE receives the data packets by starting with the data packet #1, while the cooperative UE receives the data packets by starting with a last data packet, whereby the cooperative UEs can receive the whole data.

Subsequently, the cooperative UE forwards the received data packets to the final UE by real time through the application connected/activated via the WiFi network [S470].

The activated application of the UE needs to include a function of completing a communication without data loss between heterogeneous networks. The application of the final UE controls a final service to be performed in a manner of adding the data received from the cooperative UE and the data directly received from the base station together [S480]. The final UE can perform the final service through an application program in a manner of integrating data by comparing a data map received from the base station to the directly received data or the data received from the cooperative UE.

### 2^{nd} Embodiment

### UE Cooperative Communication Method while Final UE is Performing a Service Via Base Station

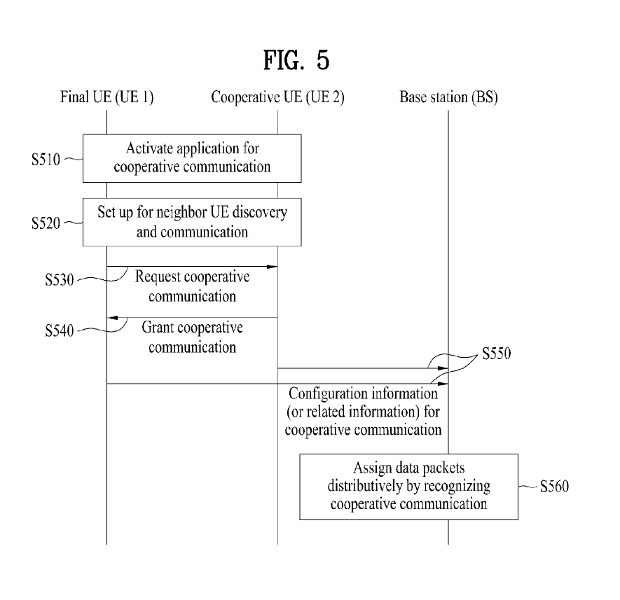

FIG. 5 is a diagram for one example to describe a UE cooperative communication method according to a 2^{nd} embodiment of the present invention.

Referring to FIG. 5, the present embodiment relates to a case that a final UE is performing a service via a base station. The final UE activates an application for a cooperative communication [S510]. Like FIG. 4, UEs for the cooperative communication performs a discovery and communication setup process with such a UE in short range as a cooperative UE [S520]. The final UE makes a request for the cooperative communication to the cooperative UE after the discovery [S530]. If the cooperative UE is prepared for the cooperative communication, the cooperative UE grants or accepts the request [S540]. After completion of the above process, the two UEs are ready to exchange data with each other. The final UE may transmit a configuration information for the cooperative communication or an individual UE may transmit the configuration information to the base station [S550]. In this case, the cooperative UE information and the final UE information as the same as described with reference to FIG. 4. The base station recognizes the cooperative communication based on the information(s) transmitted from the UE(s) and then performs a series of steps related to data distribution for a service [S560]. And, subsequent steps are the same as described with reference to FIG. 4.

### 3^{rd} Embodiment

### Another UE Cooperative Communication Method while Final UE is not Performing a Service Via Base Station

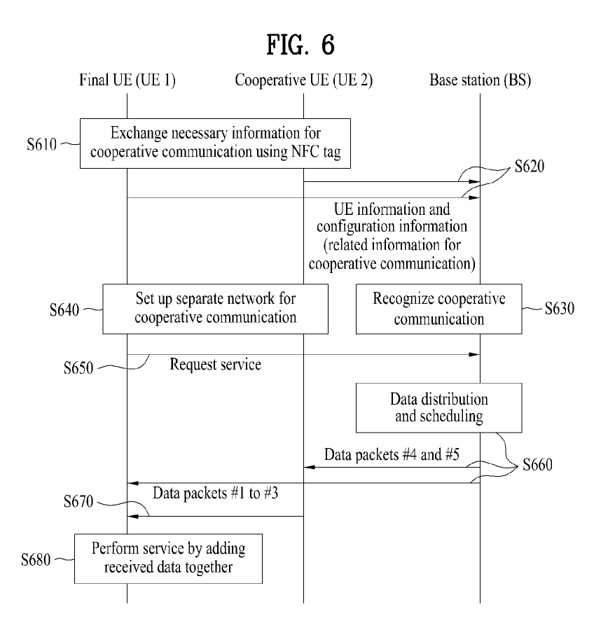

FIG. 6 is a diagram for one example of simplifying the procedure according to the 1^{st} embodiment of the present invention. Specially-unmentioned parts of the present embodiment may be performed according to the contents of the 1^{st} embodiment.

Referring to FIG. 6, information necessary for a cooperative communication is exchanged between a final UE and a cooperative UE using NFC tag (or a short range direct communication scheme that can replace the NFC tag) [S610]. This is named a 1^{st} local networking setup. In doing so, the information exchanged between the two UEs includes a series of information for UE identification. By this identification information, a base station should be able to identify the two UEs from each other. If the NFC communication is completed, the two UEs are prepared for the cooperative communication. And, the UE information exchange via the NFC tag and a procedure for a device-to-device communication are completed.

Subsequently, the UE and configuration informations for the cooperative communication are notified to the base station [S620]. Based on these informations, the base station recognizes that a cooperative communication based service will be supported between the two UEs [S630].

Aside from transmitting the cooperative communication related information to the base station, a separate network for an actual cooperative communication can be set up between the two cooperative communication UEs [S640]. This shall be named a 2^{nd} local networking setup. For instance, although the initial cooperative communication related information is exchanged between the two UEs by NFC in the 1^{st} local networking setup process, since a data transmission in an actual cooperative communication process may not be performed by NFC (e.g., Wi-Fi, Wi-Fi Direct, etc.), the connection and discovery between the two UEs are performed in advance by the 2^{nd} local networking setup process. This process is performed in doing so or may be performed right after a presence of a request for a specific service.

If a specific one (e.g., a final UE in FIG. 6) of the two UEs makes a request for a service to the base station (i.e., the corresponding UE is recognized as the final UE) [S650], subsequent steps are performed in a following manner. First of all, in doing so, a cooperative communication is performed on all services or may be performed on a previously agreed service (e.g., a service except voice, several specific applications, etc.) only. The base station optimizes data distribution and scheduling for each UE and then transmits corresponding data to the corresponding UE [S660].

The cooperative UE transmits the received data to the final UE via the 2^{nd} local networking set-up network [S670]. The final UE performs a service by adding the data directly received from the base station and the data received from the cooperative UE together [S680].

### 4^{th} Embodiment

### Another UE Cooperative Communication Method while Final UE is Performing a Service Via Base Station

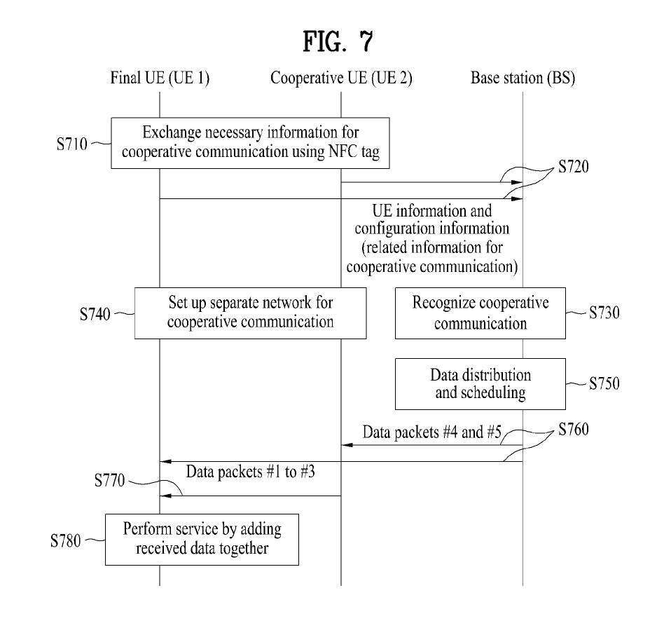

FIG. 7 is a diagram for one example of simplifying the procedure according to the 2^{nd} embodiment of the present invention. Specially-unmentioned parts of the present embodiment may be performed according to the contents of the 2^{nd} embodiment.

Referring to FIG. 7, information necessary for a cooperative communication is exchanged between a final UE and a cooperative UE using NFC tag (or a short range direct communication scheme that can replace the NFC tag) [S710]. This is named a 1^{st} local networking setup. In doing so, the information exchanged between the two UEs includes a series of information for UE identification. By this identification information, a base station should be able to identify the two UEs from each other. Subsequently, the UE and configuration informations for the cooperative communication are notified to the base station [S720]. Generally, it is able to assume that the final UE currently performing a service transmits the corresponding information to the base station, by which the present invention may be non-limited. In particular, the cooperative UE can transmit the UE information and the configuration information to the base station.

Based on these informations, the base station recognizes that the currently performed service is performed as a cooperative communication based service [S730]. Aside from transmitting the cooperative communication related information to the base station, a separate network for an actual cooperative communication can be set up between the two cooperative communication UEs [S740]. This shall be named a 2^{nd} local networking setup. For instance, although the initial cooperative communication related information is exchanged between the two UEs by NFC in the 1^{st} local networking setup process, since a data transmission in an actual cooperative communication process may not be performed by NFC (e.g., Wi-Fi, Wi-Fi Direct, etc.), the connection and discovery between the two UEs are performed by the 2^{nd} local networking setup process.

The base station optimizes data distribution and scheduling for each UE [S750] and then transmits corresponding data to the corresponding UE [S760]. In doing so, if an information for enabling both of the base station and the final UE to know the information indicating that the currently performed service is switched to the cooperative communication from what timing point is necessary, the corresponding information can be mutually transmitted.

The cooperative UE transmits the received data to the final UE via the 2^{nd} local networking set-up network [S770]. The final UE performs a service by adding the data directly received from the base station and the data received from the cooperative UE together [S780].

Thereafter, if it is necessary to terminate the cooperative communication, the following procedure may proceed. First of all, the cooperative communication termination can be mutually negotiated via the 1^{st} local networking. Secondly, the termination is notified to the base station. In general, the final UE can make the notification. The base station makes a necessary notification to the final UE and the cooperative UE in response to the notification of the termination.

### 5^{th} Embodiment

### Method of Maintaining Cooperative Communication During or after Performing Handover by One UE in the Course of Performing Cooperative Communication by UEs

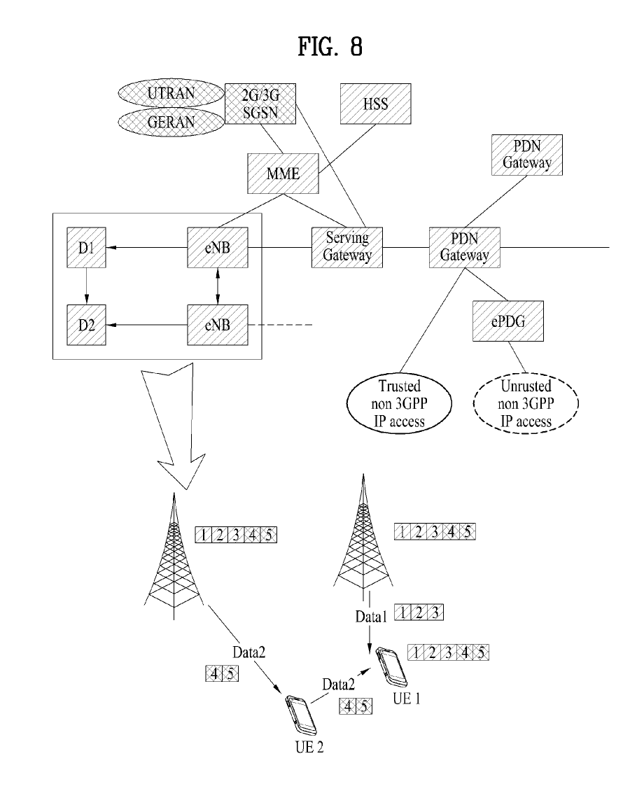

FIG. 8 is a diagram for a UE cooperative communication and handover according to an embodiment of the present invention.

Although FIG. 3 shows that a UE cooperative communication is performed via one eNB, in case that one of user equipments performing a cooperative communication makes a handover in FIG. 8, the following method is necessary to continuously perform a UE cooperative communication.

First of all, before a handover is performed, an eNB informs an eNB, which has performed a handover or will perform a handover, of information on a cooperative communication via an X2 interface or a direct air interface or by an inter-eNB communication method except the X2 interface. To this end, the following informations should be added except the information necessary to perform a general handover.
Unique identification information of user equipments in cooperative communication
Information on roles of user equipments in cooperative communication
User equipment helping a cooperative communication, a final user equipment in a cooperative communication, etc.
Whole data information and distributed packet scheduling information as information on data packets

The above-mentioned informations are shared between base stations, whereby a UE 1 can support a UE cooperative communication in the course of performing a handover or after performing the handover.

Meanwhile, if one UE makes a handover in the course of a cooperative communication, the UE stops the cooperative communication and enables a base station to receive the corresponding data only. To this end, before the handover, a serving eNB needs to additionally transmit the following information to a target eNB, into which the handover has made or will make, as well as general handover information.
Information indicating that a corresponding user equipment is the user equipment in the course of a cooperative communication [particularly, information on a cooperative communication UE/final UE is included]
Packet distributive scheduling information used by a previous base station based on the information indicating that the corresponding user equipment is the user equipment in the course of the cooperative communication
Reception information on data (e.g., data packets #4 and #5) received from a cooperative UE in case that a UE making a handover is a final UE, Information on data (e.g., data packets #4 and #5) received by a cooperative UE in case that a handover UE is a cooperative UE
Information indicating whether corresponding data (e.g., data packets #4 and #5) has been completely transmitted to a final UE or information on a method for a base station to make a request for a presence or non-presence of a reception of data having been completely transmitted by the base station to a final UE in case that a cooperative UE makes a handover

As mentioned in the above description, even if one of user equipments performing a cooperative communication makes a handover, the informations proposed by the present invention are necessary to continuously perform a UE cooperative communication as well as information exchanged between base stations in case of a general handover.

According to the various embodiments of the present invention mentioned in the foregoing description, implementation of a UE cooperative communication using a cellular network is facilitated. Thus UE cooperative communication method using the cellular network may be effective if a final UE and a cooperative UE differs from each other in communication environment or a power owned by the final UE is low. The present invention enables a cooperative communication for enhancing communication performance in a manner as follows. First of all, a cooperative UE in a good communication environment forwards a partial data from a base station to a final UE in a poor communication environment. Secondly, a final UE receives data of a base station from a cooperative UE if the final UE needs to receive data at a low power level due to a weak power currently owned by the final UE.

The above-described embodiments may correspond to combinations of elements and features of the present invention in prescribed forms. And, it may be able to consider that the respective elements or features may be selective unless they are explicitly mentioned. Each of the elements or features may be implemented in a form failing to be combined with other elements or features. Moreover, it may be able to implement an embodiment of the present invention by combining elements and/or features together in part. A sequence of operations explained for each embodiment of the present invention may be modified. Some configurations or features of one embodiment may be included in another embodiment or can be substituted for corresponding configurations or features of another embodiment. And, it is apparently understandable that a new embodiment may be configured by combining claims failing to have relation of explicit citation in the appended claims together or may be included as new claims by amendment after filing an application.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

What is claimed is:

1. A method of performing a UE-to-UE cooperative communication by a user equipment (UE) in a wireless communication system, the method comprising:
activating an application to perform the UE-to-UE cooperative communication;
receiving first data via a first network from a base station recognizing that the application has been activated;
receiving second data via a second network from a cooperative user equipment linked for the UE-to-UE cooperative communication; and
performing a service by adding the first data and the second data together through the application,
wherein the first network and the second network correspond to heterogeneous networks, respectively.

2. The method of claim 1, further comprising:
transmitting related information for the UE-to-UE cooperative communication to the base station in accordance with the application activation.

3. The method of claim 2, wherein the related information for the UE-to-UE cooperative communication comprises information indicating that the user equipment comprises a final user equipment receiving the first data and the second data and that the cooperative user equipment comprises a user equipment forwarding the second data received from the base station to the user equipment and cooperative communication group identifier information for identifying user equipments by cooperative communication groups.

4. The method of claim 2, wherein the related information for the UE-to-UE cooperative communication further comprises information on a service requested to the base station by the user equipment.

5. The method of claim 1, wherein the first network comprises a cellular network and wherein the second network comprises a WiFi network.

6. The method of claim 1, further comprising:
forming a link for the cooperative communication with the cooperative user equipment in a manner of discovering a neighbor user equipments for the UE-to-UE cooperative communication and setting a prescribed one of the discovered user equipments as the cooperative user equipment.

7. A method of performing a UE-to-UE cooperative communication by a user equipment (UE) in a wireless communication system, the method comprising:
activating an application to perform the UE-to-UE cooperative communication;
receiving first data via a first network from a base station recognizing that the application has been activated; and
transmitting the received first data to a user equipment linked to the user equipment for the UE-to-UE cooperative communication via a second network using the application,
wherein the first network and the second network correspond to heterogeneous networks, respectively.

8. The method of claim 7, further comprising:
transmitting related information for the UE-to-UE cooperative communication to the base station in accordance with the application activation.

9. The method of claim 8, wherein the related information for the UE-to-UE cooperative communication comprises information indicating that the user equipment comprises a final user equipment receiving the first data and the second data and that the cooperative user equipment comprises a user equipment forwarding the second data received from the base station to the user equipment and cooperative communication group identifier information for identifying user equipments by cooperative communication groups.

10. The method of claim 7, wherein the first network comprises a cellular network and wherein the second network comprises a WiFi network.

11. A user equipment for performing a UE-to-UE cooperative communication in a wireless communication system, the user equipment comprising:
a receiver; and
a processor configured to activate an application to perform the UE-to-UE cooperative communication, the processor controlling the receiver to receive first data via a first network from a base station recognizing that the application has been activated, the processor controlling the receiver to receive second data via a second network from a cooperative user equipment linked for the UE-to-UE cooperative communication, the processor controlling a service to be performed by adding the first data and the second data together through the application,
wherein the first network and the second network correspond to heterogeneous networks, respectively.

12. The user equipment of claim 11, further comprising:
a transmitter,
wherein the processor configured to control the transmitter to transmit a related information for the UE-to-UE cooperative communication to the base station in accordance with the application activation.

13. The user equipment of claim 12, wherein the related information for the UE-to-UE cooperative communication comprises information indicating that the user equipment comprises a final user equipment receiving the first data and the second data and that the cooperative user equipment comprises a user equipment forwarding the second data received from the base station to the user equipment and cooperative communication group identifier information for identifying user equipments by cooperative communication groups.

14. A user equipment for performing a UE-to-UE cooperative communication in a wireless communication system, the user equipment comprising:
a receiver;
a transmitter; and
a processor configured to activate an application to perform the UE-to-UE cooperative communication, the processor controlling the receiver to receive first data via a first network from a base station recognizing that the application has been activated, the processor controlling the transmitter to transmit the received first data to a user equipment linked to the user equipment for the UE-to-UE cooperative communication via a second network using the application,
wherein the first network and the second network correspond to heterogeneous networks, respectively.

15. The user equipment of claim 14, wherein the processor controls the transmitter to further transmit related information for the UE-to-UE cooperative communication to the base station in accordance with the application activation.
